(19) United States
(12) Patent Application Publication
(10) Pub. No.: US 2022/0012548 A1
(43) Pub. Date: Jan. 13, 2022

(54) OPTIMIZATION DEVICE, GUIDANCE SYSTEM, OPTIMIZATION METHOD, AND PROGRAM

(71) Applicant: NIPPON TELEGRAPH AND TELEPHONE CORPORATION, Tokyo (JP)

(72) Inventors: Hidetaka ITO, Tokyo (JP); Kyota TSUTSUMIDA, Tokyo (JP); Tatsushi MATSUBAYASHI, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/289,220

(22) PCT Filed: Oct. 25, 2019
(86) PCT No.: PCT/JP2019/041994

§ 371 Date: Apr. 27, 2021

(30) Foreign Application Priority Data
Oct. 31, 2018 (JP) 2018-205831

(51) Int. Cl. G06K 9/62; G01C 21/34; G06N 20/00

(52) U.S. Cl. CPC G06K 9/6277; G06N 20/00; G01C 21/34

(57) ABSTRACT

Upper-order parameters and lower-order parameters can be optimized by performing evaluation a small number of times. An optimization apparatus 10 includes: an evaluation unit 300 that performs calculation based on evaluation data, an upper-order parameter z, and a lower-order parameter x, and outputs an evaluation value indicating an evaluation on the calculation result; an optimization unit 100 that optimizes the upper-order parameter z and the lower-order parameter x; and an output unit 400 that outputs the optimized upper-order parameter z and lower-order parameter x that are obtained by repeating processing in the evaluation unit 300 and processing in the evaluation unit 300. The optimization unit 100 learns a model for predicting evaluation values y based on combinations of the evaluation value y, the upper-order parameter z, and the lower-order parameter x, selects the upper-order parameter z to be used in evaluation performed by the evaluation unit 300 next, and determines the lower-order parameter x to be used in evaluation performed by the evaluation unit 300 next from among lower-order parameters x corresponding to the selected upper-order parameter z based on the learnt model.

### TECHNICAL FIELD

The present disclosure relates to an optimization apparatus, a guidance system, an optimization method, and a program.

### BACKGROUND ART

In recent years, the importance of parameter adjustment in machine learning, simulations, and the like is increasing. For example, in machine learning, there are parameters that are determined in advance. Furthermore, in simulations involving, for example, humans and vehicles also, there are parameters that are determined in advance (NPL 1). Herein, the result of machine learning and simulations is referred to as an evaluation value. In such machine learning and simulations, there are issues of parameter adjustment that makes an evaluation value more appropriate. For example, in a case where a large evaluation value is favorable, it is necessary to determine parameters, that is to say, optimize parameters, so that the evaluation value is maximized by adjusting parameters through trial and error. Along with recent developments of machine learning and simulations, a period taken by single evaluation is long. In view of this, a technique to optimize parameters with less trial and error has been proposed (NPL 2).

### CITATION LIST

### Non Patent Literature

[NPL 1] Krajzewicz, D., Brockfeld, E., Mikat, J., Ringel, J., Rossel, C., Tuchscheerer, W., Wagner, P., and Wosler, R.: Simulation of modern Traffic Lights Control Systems using the open source Traffic Simulation SUMO, Proceedings of the 3rd Industrial Simulation Conference 2005, pp. 299-302 (2005).
[NPL 2] Shahriari, B., Swersky, K., Wang, Z., Adams, R. P. and Freitas, de N.: Taking the human out of the loop: A review of bayesian optimization, Proceedings of the IEEE, Vol. 104, No. 1, pp. 148-175 (2016).

### SUMMARY OF THE INVENTION

### Technical Problem

The present disclosure deals with a case where, in connection with the aforementioned issues of parameter optimization, parameters have hierarchical dependency relationships with one another. Hierarchical dependency relationships require that, depending on a value of a certain parameter, another certain parameter needs to be taken into consideration.

Take, for example, guiding of a person. In a case where whether to guide a person is used as one parameter, a new parameter that determines the way of guidance, that is to say, how to provide guidance, is required when the person is to be guided. When guidance is not to be provided, this new parameter that designates the way of guidance need not be taken into consideration, and does not influence the simulation result. This is the case where hierarchical dependency relationships exist among parameters.

Take machine learning as another example. A neural net is one type of machine learning. In the neural net, the number of network layers is used as a parameter. Here, when the number of network layers is two, parameters related to a network in the third layer need not be taken into consideration. On the other hand, when the number of network layers is three, it is necessary to take into consideration parameters related to the network in the third layer. This is the case where hierarchical dependency relationships exist among parameters.

In the case of these examples, parameters can be divided into two types: parameters that influence other parameters, and parameters that are influenced by other parameters. In view of this, the former are referred to as upper-order parameters, whereas the latter are referred to as lower-order parameters. In the above-described examples, whether to guide a person and the number of network layers are each an upper-order parameter. On the other hand, the way of guidance and parameters related to networks in respective layers are each a lower-order parameter.

When hierarchical dependency relationships exist among parameters in the above-described manner, it is necessary to optimize both upper-order parameters and lower-order parameters.

The present disclosure has been made in view of the foregoing, and it is an object thereof to provide an optimization apparatus, a guidance system, an optimization method, and a program that can optimize upper-order parameters and lower-order parameters by performing evaluation a small number of times.

### Means for Solving the Problem

To achieve the aforementioned object, an optimization apparatus according to a first aspect of the present disclosure is an optimization apparatus that optimizes an upper-order parameter and a lower-order parameter, the upper-order parameter being used in calculation based on input evaluation data, the lower-order parameter being influenced by the upper-order parameter, the optimization apparatus including: an evaluation unit that performs the calculation based on the evaluation data, the upper-order parameter, and the lower-order parameter, and outputs an evaluation value indicating an evaluation on a calculation result; an optimization unit that optimizes the upper-order parameter and the lower-order parameter; and an output unit that outputs the optimized upper-order parameter and lower-order parameter that are obtained by repeating processing in the evaluation unit and processing in the optimization unit, wherein the optimization unit learns a model for predicting evaluation values based on combinations of the evaluation value, the upper-order parameter, and the lower-order parameter, selects the upper-order parameter to be used in evaluation performed by the evaluation unit next, and determines the lower-order parameter to be used in evaluation performed by the evaluation unit next from among lower-order parameters corresponding to the selected upper-order parameter based on the learnt model.

An optimization apparatus according to a second aspect of the present disclosure is the optimization apparatus according to the first aspect, wherein the optimization unit predicts the evaluation values respectively for the lower-order parameters using the model, calculates acquisition functions in which prediction of the evaluation values for the lower-order parameters is a variable, and determines the lower-order parameter corresponding to the maximum or minimum acquisition function as the lower-order parameter to be used in evaluation performed by the evaluation unit next.

An optimization apparatus according to a third aspect of the present disclosure is the optimization apparatus according to the first aspect or the second aspect, wherein the model is a probability model that uses a Gaussian process.

An optimization apparatus according to a fourth aspect of the present disclosure is the optimization apparatus according to any one of the first aspect to the third aspect, wherein the optimization unit learns the model based on the evaluation value obtained through processing in the evaluation unit, the upper-order parameter, and the lower-order parameter.

To achieve the aforementioned object, a guidance system according to a fifth aspect of the present disclosure is a guidance system including a guidance apparatus for controlling guiding of a pedestrian and an optimization apparatus that optimizes an upper-order parameter and a lower-order parameter, the upper-order parameter being used in calculation based on input evaluation data that is necessary for calculating a status of the pedestrian, the lower-order parameter being influenced by the upper-order parameter, the guidance apparatus including a control unit that controls guiding of the pedestrian using the upper-order parameter and the lower-order parameter obtained by the optimization apparatus, the optimization apparatus including: an evaluation unit that performs the calculation based on the evaluation data, the upper-order parameter, and the lower-order parameter, and outputs an evaluation value indicating an evaluation on a calculation result; an optimization unit that optimizes the upper-order parameter and the lower-order parameter; and an output unit that outputs the optimized upper-order parameter and lower-order parameter that are obtained by repeating processing in the evaluation unit and processing in the optimization unit, wherein the optimization unit learns a model for predicting evaluation values based on combinations of the evaluation value, the upper-order parameter, and the lower-order parameter, selects the upper-order parameter to be used in evaluation performed by the evaluation unit next, and determines the lower-order parameter to be used in evaluation performed by the evaluation unit next from among lower-order parameters corresponding to the selected upper-order parameter based on the learnt model.

To achieve the aforementioned object, an optimization method according to a sixth aspect of the present disclosure is an optimization method that optimizes an upper-order parameter and a lower-order parameter, the upper-order parameter being used in calculation based on input evaluation data, the lower-order parameter being influenced by the upper-order parameter, the optimization method including: with an evaluation unit, performing the calculation based on the evaluation data, the upper-order parameter, and the lower-order parameter, and outputting an evaluation value indicating an evaluation on a calculation result; with an optimization unit, optimizing the upper-order parameter and the lower-order parameter; and with an output unit, outputting the optimized upper-order parameter and lower-order parameter that are obtained by repeating processing in the evaluation unit and processing in the optimization unit, wherein the optimizing with the optimization unit includes: learning a model for predicting evaluation values based on combinations of the evaluation value, the upper-order parameter, and the lower-order parameter; selecting the upper-order parameter to be used in evaluation performed by the evaluation unit next; and determining the lower-order parameter to be used in evaluation performed by the evaluation unit next from among lower-order parameters corresponding to the selected upper-order parameter based on the learnt model.

To achieve the aforementioned object, a program according to a seventh aspect of the present disclosure is a program for causing a computer to function as each unit of the optimization apparatus according to any one of the first aspect to the fourth aspect.

### Effects of the Invention

The present disclosure can achieve an advantageous effect whereby upper-order parameters and lower-order parameters can be optimized by performing evaluation a small number of times.

### BRIEF DESCRIPTION OF DRAWINGS

FIG. 1 is a block diagram showing a configuration of one example of a guidance system according to an embodiment.

FIG. 2 is a diagram showing an example of a part of information stored in a parameter and evaluation value storage unit according to an embodiment.

FIG. 3 is a flowchart showing one example of an optimization processing routine in an optimization apparatus according to an embodiment.

### DESCRIPTION OF EMBODIMENTS

The following describes an embodiment of the present disclose in detail with reference to the drawings. As one example, the present embodiment is described in relation to a mode in which an optimization apparatus according to the present disclosure is applied to a guidance system that optimizes parameters of a guidance apparatus that guides pedestrians based on evaluation values that are calculated from the result of performing a simulation of a flow of pedestrians, that is to say, a human flow (hereinafter referred to as a “human flow simulation”).

<Configuration of Guidance System According to Present Embodiment>

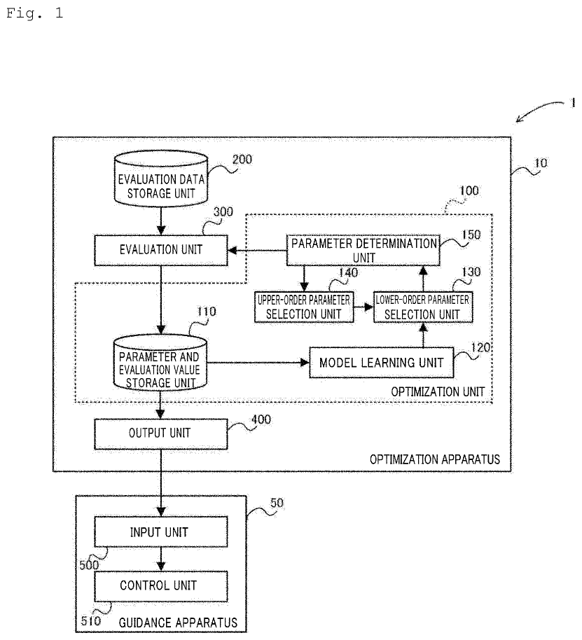

FIG. 1 is a block diagram showing a configuration of one example of a guidance system according to an embodiment. As shown in FIG. 1, a guidance system 1 according to the present embodiment includes an optimization apparatus 10 and a guidance apparatus 50.

As one example, the optimization apparatus 10 according to the present embodiment can be composed of a computer that includes a CPU (Central Processing Unit), a RAM (Random Access Memory), and a ROM (Read Only Memory) that stores a program and various types of data for executing a later-described optimization processing routine. Specifically, the CPU that has executed the aforementioned program functions as an optimization unit 100, an evaluation unit 300, and an output unit 400 of the optimization apparatus 10 shown in FIG. 1.

As shown in FIG. 1, the optimization apparatus 10 according to the present embodiment includes an optimization unit 100, an evaluation data storage unit 200, an evaluation unit 300, and an output unit 400.

The evaluation data storage unit 200 stores evaluation data that is necessary for the evaluation unit 300 to perform a human flow simulation. The evaluation data is data that is necessary for calculating the statuses of pedestrians in providing guidance. Examples of the evaluation data include, but are not limited to, road shapes, the moving speed of pedestrians, the number of pedestrians, the time at which each pedestrian enters a simulation section, the routes taken by the pedestrians, the start time and the end time of the human flow simulation, and the like. Such evaluation data is input from the outside of the optimization apparatus 10 to the evaluation data storage unit 200 at arbitrary timings, and is output to the evaluation unit 300 in accordance with an instruction from the evaluation unit 300.

The evaluation unit 300 performs the human flow simulation based on the evaluation data, an upper-order parameter z, and a lower-order parameter x, and derives an evaluation value y.

In the present embodiment, as one example, an upper-order parameter z is a parameter related to whether to guide pedestrians, and a lower-order parameter x is a parameter that determines a guidance method when guidance is to be provided. Furthermore, as one example, an evaluation value y, which is the result of the human flow simulation, is a period required by pedestrians to reach a destination.

Specifically, the obtained evaluation data is input from the evaluation data storage unit 200 to the evaluation unit 300.

Also, an upper-order parameter z and a lower-order parameter x for the next human flow simulation are input from a parameter determination unit 150 to the evaluation unit 300. In other words, provided that the number of times the human flow simulation has been performed is t, an upper-order parameter zₜ₊₁ and a lower-order parameter xₜ₊₁ for the (t+1)th human flow simulation are input from the parameter determination unit 150 to the evaluation unit 300. Note that t, which represents the number of times the simulation has been performed, indicates the order in which the evaluation unit 300 has performed evaluation, that is to say, the order of the human flow simulations.

The optimization unit 100 optimizes an upper-order parameter z and a lower-order parameter x of the human flow simulation in the evaluation unit 300. As shown in FIG. 1, the optimization unit 100 according to the present embodiment includes a parameter and evaluation value storage unit 110, a model learning unit 120, a lower-order parameter selection unit 130, an upper-order parameter selection unit 140, and a parameter determination unit 150.

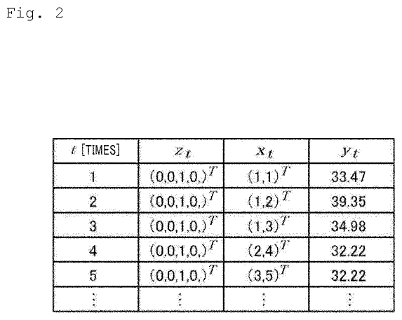

The parameter and evaluation value storage unit 110 stores data of the human flow simulations that have been performed by the evaluation unit 300 in the past, which has been input from the evaluation unit 300. Specifically, the data stored in the parameter and evaluation value storage unit 110 is an upper-order parameter zₜ, a lower-order parameter xₜ, and an evaluation value yₜ that were selected and derived in the t-th human flow simulation (where t=0, 1, 2, . . . ). The collections of upper-order parameters zₜ, lower-order parameters xₜ, and evaluation values yₜ corresponding to t=0, 1, 2, . . . are respectively denoted by Z, X, and Y. FIG. 2 shows one example of a part of stored information.

Furthermore, the parameter and evaluation value storage unit 110 also stores a correspondence table of hierarchical dependency relationships between upper-order parameters z and lower-order parameters x. The correspondence table of the dependency relationships is input from the outside of the optimization apparatus 10 to the parameter and evaluation value storage unit 110 at an arbitrary timing.

The model learning unit 120 learns a model based on the collection Z of upper-order parameters z, the collection X of lower-order parameters x, and the collection Y of evaluation values y stored in the parameter and evaluation value storage unit 110.

Specifically, the model learning unit 120 obtains the collection Z of upper-order parameters z, the collection X of lower-order parameters x, and the collection Y of evaluation values y stored in the parameter and evaluation value storage unit 110. Then, the optimization apparatus 10 learns a Gaussian process, which is a probability model, as an example of a model based on the collection Z of upper-order parameters z, the collection X of lower-order parameters x, and the collection Y of evaluation values y (Reference Literature 1). The model learning unit 120 further outputs the learnt model to the lower-order parameter selection unit 130.

[Reference Literature 1] Rasmussen, C. E. and Williams, C. K. I.: Gaussian processes for machine learning, MIT Press (2006).

By using regression in the Gaussian process, an unknown evaluation value y can be inferred as a probability distribution in the form of normal distribution with respect to an arbitrary input x. Also, any kernel may be used in relation to x. One example is a Gaussian kernel provided by the following expression (1) (NPL 2). Furthermore, θ in the following expression (1) is a parameter with a real number. As one example of θ, the result of point estimation of a value that maximizes the marginal likelihood of the Gaussian process is used (Reference Literature 1).

[Formula 1]

k(x₁,x₂)=e^{-|x}^{₁}^{-x}^{₂}^{|}^{²}^{/θ} (1)

Note that by learning a model that estimates an evaluation value y with respect to a lower-order parameter x, the optimization apparatus 10 according to the present embodiment learns a model that estimates an evaluation value y with respect to an upper-order parameter z and a lower-order parameter x based on the correspondence table of the hierarchical dependency relationships between upper-order parameters z and lower-order parameters x, which is stored in the parameter and evaluation value storage unit 110.

Then, the model learning unit 120 outputs the learnt model of the Gaussian process to the lower-order parameter selection unit 130.

The upper-order parameter selection unit 140 selects an upper-order parameter candidate zₜ₊₁ to be used in the next evaluation, and outputs the same to the lower-order parameter selection unit 130.

The lower-order parameter selection unit 130 performs regression in the Gaussian process, which is the model input from the model learning unit 120, and calculates a function indicating the extent at which the evaluation unit 300 should perform the human flow simulation next using a lower-order parameter xₜ₊₁. This is referred to as an acquisition function α(x). One example of the acquisition function α(x) is the upper confidence bound provided by the following expression (2) (NPL 2).

[Formula 2]

α(x)=μₜ(x)+\sqrt{βₜ₊₁}σₜ(x) (2)

Here, μₜ(x) and σₜ(x) are respectively the average and variance obtained by regression in the Gaussian process, and βₜ₊₁ is a parameter. For example,

βₜ₊₁=log t

can be used.

Then, a lower-order parameter xₜ₊₁ that maximizes the acquisition function α(x) under the condition in which the upper-order parameter zₜ₊₁ to be used in the next evaluation is given, is output to the parameter determination unit 150. Here, provided that

X_{z}_{ₜ₊₁}

is the collection of values that the lower-order parameter xₜ₊₁ can take given the upper-order parameter zₜ₊₁, the lower-order parameter xₜ₊₁ that maximizes the acquisition function α(x) is provided by the following expression (3).

$$\begin{matrix}[ Formula 3 ] & \\ {x}_{t + 1} = arg {max}_{x ∈ {X}_{{z}_{t + 1}}} a ( x ) & ( 3 )\end{matrix}$$

Also, the lower-order parameter selection unit 130 refers to the correspondence table of the hierarchical dependency relationships between upper-order parameters z and lower-order parameters x, which is stored in the parameter and evaluation value storage unit 110. Then, with respect to all upper-order parameter candidates

Ź,

the lower-order parameter selection unit 130 outputs the lower-order parameter candidates that maximize the acquisition function α(x),

\acute{X},

to the parameter determination unit 150 under the condition in which the upper-order parameter candidates

Ź

are given. Here, provided that the collection of values that the lower-order parameter x can take is

X_{Ź}

given the upper-order parameter candidates

Ź,

the lower-order parameter candidates that maximize the acquisition function α(x),

\acute{X},

are provided by the following expression (4).

$$\begin{matrix}[ Formula 4 ] & \\ {x}^{′} = arg {max}_{x ∈ {X}_{{z}^{′}}} α ( x ) & ( 4 )\end{matrix}$$

Furthermore, with respect to all lower-order parameter candidates

\acute{X},

the lower-order parameter selection unit 130 compares

\acute{X}

with xₜ₊₁, and determines which one is a favorable lower-order parameter x to be used in performing the human flow simulation next. Here, as an example of a ground for determining which one is favorable, the one that makes the value of the acquisition function α(x) large can be regarded favorable. That is to say, the lower-order parameter selection unit 130 compares the acquisition function α(xₜ₊₁) with the acquisition function

α(\acute{X})

and outputs information indicating which one is favorable as the comparison result to the parameter determination unit 150.

Based on the upper-order parameter candidates

Ź

and the lower-order parameter candidates

\acute{X}

that have been input from the lower-order parameter selection unit 130, the parameter determination unit 150 determines the upper-order parameter zₜ₊₁ and the lower-order parameter xₜ₊₁.

Specifically, the parameter determination unit 150 replaces the lower-order parameter xₜ₊₁ with the lower-order parameter candidates as indicated by the following expression (5).

Furthermore, the upper-order parameter zₜ₊₁ is replaced with the upper-order parameter candidates

Ź

as indicated by the following expression (6).

[Formula 5]

xₜ₊₁=\acute{x} (5)

zₜ₊₁=ź (6)

In addition, based on the upper-order parameters zₜ₊₁ and the lower-order parameters xₜ₊₁ that have been obtained from the aforementioned expressions (5) and (6), the parameter determination unit 150 determines whether the selections of the upper-order parameter candidates

Ź

and the lower-order parameter candidates

\acute{X}

are sufficient. Here, one example of a method that determines whether the selections of the candidates are sufficient is a method that determines the selections of the upper-order parameter candidates

Ź

and the lower-order parameter candidates

\acute{X}

to be sufficient if none of all lower-order parameter candidates

\acute{X}

was more favorable than the lower-order parameter xₜ₊₁ when the upper-order parameter zₜ₊₁ and the lower-order parameter xₜ₊₁ were selected previously. When the parameter determination unit 150 determines that the selections of the candidates are sufficient, it outputs information of the upper-order parameter zₜ₊₁ and the lower-order parameter xₜ₊₁ to the evaluation data storage unit 200. On the other hand, when the parameter determination unit 150 determines that the selections of the candidates are not sufficient, it outputs the upper-order parameter candidates

Ź

to the upper-order parameter selection unit 140.

The output unit 400 outputs the optimum upper-order parameter z and lower-order parameter x to the outside of the optimization apparatus 10. Specifically, the output unit 400 according to the present embodiment refers to evaluation values stored in the parameter and evaluation value storage unit 110, and outputs an upper-order parameter z and a lower-order parameter x corresponding to the maximum evaluation value as the optimum upper-order parameter z and lower-order parameter x to the guidance apparatus 50.

The guidance apparatus 50 is an apparatus for controlling guiding of pedestrians. By designating an upper-order parameter z and a lower-order parameter x, whether to provide guidance, more specifically, whether to provide guidance in each of a plurality of predetermined locations, as well as the way of guidance when guidance is to be provided, is uniquely determined.

As one example, the guidance apparatus 50 according to the present embodiment can be composed of a computer that includes a CPU, a RAM, and a ROM that stores a program and various types of data for controlling guiding of pedestrians. Specifically, the CPU that has executed the aforementioned program functions as an input unit 500 and a control unit 510 of the guidance apparatus 50 shown in FIG. 1.

As shown in FIG. 1, the guidance apparatus 50 according to the present embodiment includes an input unit 500 and a control unit 510.

The input unit 500 obtains an upper-order parameter z and a lower-order parameter x from the output unit 400 of the optimization apparatus 10. Therefore, the upper-order parameter z and the lower-order parameter x are input from the output unit 400 to the input unit 500. The input unit 500 outputs the input upper-order parameter z and lower-order parameter x to the control unit 510.

The control unit 510 controls guiding of pedestrians using the upper-order parameter z and the lower-order parameter x input from the input unit 500. Specifically, based on the upper-order parameter z and the lower-order parameter x, the control unit 510 outputs information indicating a location in which pedestrians are to be guided, as well as the way of guiding pedestrians in the location in which guidance is to be provided, to the outside of the guidance apparatus 50.

<Effects of Optimization Apparatus According to Present Embodiment>

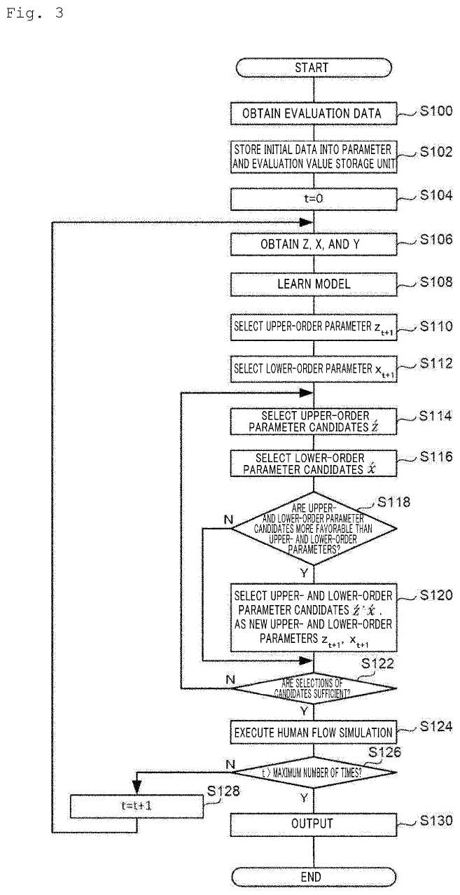

Next, the effects of the optimization apparatus 10 according to the present embodiment will be described with reference to the drawings. FIG. 3 is a flowchart showing one example of an optimization processing routine that is executed by the optimization apparatus according to the present embodiment.

The optimization processing routine shown in FIG. 3 is executed at an arbitrary timing, such as a timing at which evaluation data is stored into the evaluation data storage unit 200, a timing at which an instruction for executing the optimization processing routine is accepted from the outside of the optimization apparatus 10, and the like. Note that the optimization apparatus 10 according to the present embodiment is in a state where evaluation data that is necessary for performing the human flow simulation was stored into the evaluation data storage unit 200 in advance before the execution of the optimization processing routine.

In step S100 of FIG. 3, the evaluation unit 300 obtains evaluation data that is necessary for the human flow simulation from the parameter and evaluation value storage unit 110.

In the next step S102, the evaluation unit 300 causes the parameter and evaluation value storage unit 110 to store initial values of an upper-order parameter z, a lower-order parameter x, and an evaluation value y. The optimization apparatus 10 according to the present embodiment causes the evaluation unit 300 to perform the human flow simulation using an arbitrary upper-order parameter z and lower-order parameter x, and causes the parameter and evaluation value storage unit 110 to store one or more sets of the obtained evaluation value y, upper-order parameter z, and lower-order parameter x as initial values. Note that no particular limitation is intended with regard to the arbitrary upper-order parameter z and lower-order parameter x. For example, it is sufficient that these parameters have values that can be taken in the human flow simulation applied, and these parameters may have random values.

In the next step S104, the evaluation unit 300 sets the number of repetition t=0.

In the next step S106, the model learning unit 120 obtains X, Z, and Y from the parameter and evaluation value storage unit 110.

In the next step S108, the model learning unit 120 constructs a model, as described above, from X, Z, Y. Then, the model learning unit 120 outputs the learnt model of the Gaussian process to the lower-order parameter selection unit 130.

In the next step S110, the upper-order parameter selection unit 140 selects one upper-order parameter zₜ₊₁ to be used in performing the human flow simulation next. As one example, an upper-order parameter zₜ that was used when the evaluation unit 300 performed evaluation previously is selected.

In the next step S112, as described above, the lower-order parameter selection unit 130 establishes an acquisition function α(x) from the aforementioned expression (2) based on the learnt model.

The upper-order parameter selection unit 140 selects one or more upper-order parameter candidates

Ź

in the next step S114. One example of a selection method is a method that selects every point near the upper-order parameter zₜ₊₁.

In the next step S116, as described above, with respect to all upper-order parameter candidates

Ź,

the lower-order parameter selection unit 130 derives lower-order parameter candidates

\acute{X}

that maximize the acquisition function α(x) from the aforementioned expression (4) under the condition in which the upper-order parameter candidates

Ź

are given, and outputs the same to the parameter determination unit 150.

In the next step S118, the lower-order parameter selection unit 130 determines whether each of the upper-order parameter candidates

Ź

and the lower-order parameter candidates

\acute{X}

is better (more favorable) than the upper-order parameter zₜ₊₁ or the lower-order parameter xₜ₊₁. As described above, the lower-order parameter selection unit 130 according to the present embodiment compares the acquisition function α(xₜ₊₁) with the acquisition function

α(\acute{X}),

regards the one with a larger value favorable, and outputs information indicating which one is favorable as the comparison result to the parameter determination unit 150.

Therefore, in step S118, when the acquisition function

α(\acute{X})

is larger than the acquisition function α(x), the determination is made affirmatively, and processing proceeds to step S120.

In step S120, as described above, the parameter determination unit 150 replaces the lower-order parameter xₜ₊₁ with the lower-order parameter candidates

\acute{X}

and replaces the upper-order parameter zₜ₊₁ with the upper-order parameter candidates

Ź

as indicated by the aforementioned expressions (5) and (6). Then, processing proceeds to step S122.

On the other hand, when the acquisition function

α(\acute{X}),

is smaller than the acquisition function α(x) in step S118, the determination is made negatively, and processing proceeds to step S122.

In step S122, as described above, the parameter determination unit 150 determines whether the selections of the upper-order parameter candidates

Ź

and the lower-order parameter candidates

\acute{X}

are sufficient.

When the selections of the candidates are not sufficient, the determination is made negatively in step S122, processing returns to step S114, and processing of steps S114 to S120 is repeated. On the other hand, when the selections of the candidates are sufficient, the determination is made affirmatively in step S122, and processing proceeds to step S124. In this case, the parameter determination unit 150 outputs the upper-order parameter zₜ₊₁ and the lower-order parameter xₜ₊₁ to the evaluation unit 300.

In step S124, the evaluation unit 300 executes the human flow simulation using the evaluation data obtained from the evaluation data storage unit 200 and the upper-order parameter zₜ₊₁ and the −order parameter xₜ₊₁ that have been input from the parameter determination unit 150. The evaluation unit 300 outputs one or more evaluation values yₜ₊₁ that have been obtained as a result of the human flow simulation, as well as the upper-order parameter zₜ₊₁ and the lower-order parameter xₜ₊₁, to the parameter and evaluation value storage unit 110.

In the next step S126, the evaluation unit 300 determines whether the current number of times t the human flow simulation has been performed exceeds the preset maximum number of times the human flow simulation is repeated. One example of the maximum number of times the human flow simulation is repeated is 1000.

When the number of times t does not exceed the maximum number of times, the determination is made negatively in step S126, and processing proceeds to step S128. In step S128, the evaluation unit 300 sets t=t+1. Thereafter, processing returns to step S106, and processing of steps S106 to S124 is repeated. On the other hand, when the number of times t exceeds the maximum number of times, the determination is made affirmatively in step S126, and processing proceeds to step S130.

In step S130, the output unit 400 refers to the parameter and evaluation value storage unit 110, outputs the upper-order parameter z and the lower-order parameter x that maximize the evaluation value y to the guidance apparatus 50, and ends the present optimization processing routine.

As described above, the optimization apparatus 10 according to the present embodiment is an optimization apparatus that optimizes an upper-order parameter z, which is used in performing calculation based on input evaluation data, and a lower-order parameter x that is influenced by the upper-order parameter z. The optimization apparatus 10 includes the evaluation unit 300, the optimization unit 100, and the output unit 400. The aforementioned evaluation unit 300 performs calculation based on the evaluation data, the upper-order parameter z, and the lower-order parameter x, and outputs an evaluation value indicating an evaluation on the calculation result. The aforementioned optimization unit 100 optimizes the upper-order parameter z and the lower-order parameter x. The aforementioned output unit 400 outputs the optimized upper-order parameter z and lower-order parameter x that are obtained by repeating processing in the evaluation unit 300 and processing in the evaluation unit 300. The optimization unit 100 learns a model for predicting an evaluation value y based on combinations of an evaluation value y, an upper-order parameter z, and a lower-order parameter x. Furthermore, the optimization unit 100 selects an upper-order parameter z to be used in the next evaluation performed by the evaluation unit 300, and determines a lower-order parameter x to be used in the next evaluation performed by the evaluation unit 300 from among lower-order parameters x corresponding to the selected upper-order parameter z based on the learnt model.

The optimization apparatus 10 according to the present embodiment divides the course of parameter optimization into two stages, and makes a transition gradually from processing of the first stage to processing of the second stage. Here, the first stage denotes processing for finding the optimum parameter from among limited parameter candidates. On the other hand, the second stage denotes processing for finding the optimum parameter from among all parameter candidates. In the optimization apparatus 10 according to the present embodiment, as an evaluation value y is predicted by limiting upper-order parameters z, processing of the first stage can be performed at high speed. Furthermore, in the optimization apparatus 10, the execution of processing of the first stage makes processing of the second stage easy.

Therefore, the optimization apparatus 10 according to the present embodiment can optimize an upper-order parameter z and a lower-order parameter x by performing evaluation a small number of times.

Furthermore, the guidance system 1 according to the present embodiment is a guidance system that includes the guidance apparatus 50 for controlling guiding of pedestrians, and the optimization apparatus 10 that optimizes an upper-order parameter z, which is used in performing calculation based on input evaluation data that is necessary for calculating the statuses of pedestrians, and a lower-order parameter x that is influenced by the upper-order parameter z. The guidance apparatus 50 includes the control unit 510 that controls guiding of pedestrians using the upper-order parameter z and the lower-order parameter x obtained by the optimization apparatus 10. The optimization apparatus 10 includes the evaluation unit 300, the optimization unit 100, and the output unit 400. The aforementioned evaluation unit 300 performs calculation based on evaluation data, an upper-order parameter z, and a lower-order parameter x, and outputs an evaluation value y indicating an evaluation on the calculation result. The aforementioned optimization unit 100 optimizes the upper-order parameter z and the lower-order parameter x. The aforementioned output unit 400 outputs the optimized upper-order parameter z and lower-order parameter x that are obtained by repeating processing in the evaluation unit 300 and processing in the optimization unit 100. The optimization unit 100 learns a model for predicting an evaluation value y based on combinations of an evaluation value y, an upper-order parameter z, and a lower-order parameter x. Furthermore, the optimization unit 100 selects an upper-order parameter z to be used in the next evaluation performed by the evaluation unit 300, and determines a lower-order parameter x to be used in the next evaluation performed by the evaluation unit 300 from among lower-order parameters x corresponding to the selected upper-order parameter z based on the learnt model.

Note that the present disclosure is not limited to the above embodiment, and various changes and applications are possible without departing from the essential spirit of the present disclosure.

Although the optimization apparatus 10 according to the above embodiment has been described in relation to a mode in which an upper-order parameter z and a lower-order parameter x are optimized in a case where the optimum evaluation value y is the maximum value, no limitation is intended by this mode. For example, the optimization apparatus 10 may be used in a mode in which an upper-order parameter z and a lower-order parameter x are optimized in a case where the optimum evaluation value y is the minimum value. Note that the acquisition function α(x) is set as appropriate in accordance with what kind of value is used as the optimum evaluation value y (e.g., the maximum value or the minimum value). For example, in a case where the optimum evaluation value y is the minimum value, the acquisition function α(x) is provided by the following expression (7) instead of the aforementioned expression (2).

[Formula 6]

α(x)=μₜ(x)+\sqrt{βₜ₊₁}σₜ(x) (7)

Furthermore, although the above embodiment has been described in relation to a mode in which the optimization apparatus 10 is applied to a human flow simulation that uses an upper-order parameter z indicating whether to guide pedestrians, and a lower-order parameter x indicating the way of guidance, no limitation is intended thereby.

For example, as another embodiment, the optimization apparatus 10 can be applied to a traffic simulation that uses an upper-order parameter z indicating whether to control a traffic light, a lower-order parameter x indicating a timing of switching of the signal, and an evaluation value y indicating, for example, a period taken to reach a destination. Furthermore, for example, as another embodiment, the optimization apparatus 10 can be applied to machine learning that uses an upper-order parameter z indicating the number of network layers or a processing pipeline, a lower-order parameter x indicating a hyperparameter of an algorithm, and an evaluation value y indicating, for example, the accuracy rate of inference.

Furthermore, although the present embodiment has been described in relation to a mode in which the aforementioned program has been installed in advance, this program can be provided while being stored in a computer-readable recording medium, and can also be provided via a network.

### REFERENCE SIGNS LIST

1 Guidance system
10 Optimization apparatus
50 Guidance apparatus
100 Optimization unit
110 Parameter and evaluation value storage unit
120 Model learning unit
130 Lower-order parameter selection unit
140 Upper-order parameter selection unit
150 Parameter determination unit
200 Evaluation data storage unit
300 Evaluation unit
400 Output unit
500 Input unit
510 Control unit

1. An optimization apparatus that optimizes an upper-order parameter and a lower-order parameter, the upper-order parameter being used in calculation based on input evaluation data, the lower-order parameter being influenced by the upper-order parameter, the optimization apparatus comprising:
an evaluator configured to perform the calculation based on the evaluation data, the upper-order parameter, and the lower-order parameter, and outputs an evaluation value indicating an evaluation on a calculation result;
an optimizer configured to optimize the upper-order parameter and the lower-order parameter; and
an provider configured to output the optimized upper-order parameter and lower-order parameter that are obtained by repeating processing in the evaluator and processing in the optimizer, wherein the optimizer learns a model for predicting evaluation values based on combinations of the evaluation value, the upper-order parameter, and the lower-order parameter, selects the upper-order parameter to be used in evaluation performed by the evaluator next, and determines the lower-order parameter to be used in evaluation performed by the evaluator next from among lower-order parameters corresponding to the selected upper-order parameter based on the learnt model.

2. The optimization apparatus according to claim 1, wherein the optimizer predicts the evaluation values respectively for the lower-order parameters using the model, calculates acquisition functions in which prediction of the evaluation values for the lower-order parameters is a variable, and determines the lower-order parameter corresponding to the maximum or minimum acquisition function as the lower-order parameter to be used in evaluation performed by the evaluator next.

3. The optimization apparatus according to claim 1, wherein the model is a probability model that uses a Gaussian process.

4. The optimization apparatus according to claim 1, wherein the optimizer learns the model based on the evaluation value obtained through processing in the evaluator, the upper-order parameter, and the lower-order parameter.

5. (canceled)

6. An optimization method that optimizes an upper-order parameter and a lower-order parameter, the upper-order parameter being used in calculation based on input evaluation data, the lower-order parameter being influenced by the upper-order parameter, the optimization method comprising:
performing, by an evaluator, the calculation based on the evaluation data, the upper-order parameter, and the lower-order parameter, and outputting an evaluation value indicating an evaluation on a calculation result;
optimizing, by an optimizer, the upper-order parameter and the lower-order parameter; and
outputting, by a provider, outputting the optimized upper-order parameter and lower-order parameter that are obtained by repeating processing in the evaluator and processing in the optimizer, wherein the optimizing with the optimizer includes learning a model for predicting evaluation values based on combinations of the evaluation value, the upper-order parameter, and the lower-order parameter, selecting the upper-order parameter to be used in evaluation performed by the evaluator next, and determining the lower-order parameter to be used in evaluation performed by the evaluator next from among lower-order parameters corresponding to the selected upper-order parameter based on the learnt model.

7. A computer-readable non-transitory recording medium storing a computer-executable program instructions, which optimizes an upper-order parameter and a lower-order parameter, the upper-order parameter being used in calculation based on input evaluation data, the lower-order parameter being influenced by the upper-order parameter, that when executed by a processor cause a computer system to:
perform, by an evaluator, the calculation based on the evaluation data, the upper-order parameter, and the lower-order parameter, and outputting an evaluation value indicating an evaluation on a calculation result;
optimize, by an optimizer, the upper-order parameter and the lower-order parameter; and
output, by a provider, outputting the optimized upper-order parameter and lower-order parameter that are obtained by repeating processing in the evaluator and processing in the optimizer, wherein the optimizing with the optimizer includes learning a model for predicting evaluation values based on combinations of the evaluation value, the upper-order parameter, and the lower-order parameter, selecting the upper-order parameter to be used in evaluation performed by the evaluator next, and determining the lower-order parameter to be used in evaluation performed by the evaluator next from among lower-order parameters corresponding to the selected upper-order parameter based on the learnt model.

8. The optimization apparatus according to claim 2, wherein the model is a probability model that uses a Gaussian process.

9. The optimization apparatus according to claim 2, wherein the optimizer learns the model based on the evaluation value obtained through processing in the evaluator, the upper-order parameter, and the lower-order parameter.

10. The optimization apparatus according to claim 3, wherein the optimizer learns the model based on the evaluation value obtained through processing in the evaluator, the upper-order parameter, and the lower-order parameter.

11. The optimization method according to claim 6, wherein the optimize predicts the evaluation values respectively for the lower-order parameters using the model, calculates acquisition functions in which prediction of the evaluation values for the lower-order parameters is a variable, and determines the lower-order parameter corresponding to the maximum or minimum acquisition function as the lower-order parameter to be used in evaluation performed by the evaluator next.

12. The optimization method according to claim 6, wherein the model is a probability model that uses a Gaussian process.

13. The optimization method according to claim 6, wherein the optimizer learns the model based on the evaluation value obtained through processing in the evaluator, the upper-order parameter, and the lower-order parameter.

14. The optimization method according to claim 11, wherein the model is a probability model that uses a Gaussian process.

15. The optimization method according to claim 11, wherein the optimizer learns the model based on the evaluation value obtained through processing in the evaluator, the upper-order parameter, and the lower-order parameter.

16. The optimization method according to claim 12, wherein the optimizer learns the model based on the evaluation value obtained through processing in the evaluator, the upper-order parameter, and the lower-order parameter.

17. The computer-readable non-transitory recording medium according to claim 7, wherein the optimize predicts the evaluation values respectively for the lower-order parameters using the model, calculates acquisition functions in which prediction of the evaluation values for the lower-order parameters is a variable, and determines the lower-order parameter corresponding to the maximum or minimum acquisition function as the lower-order parameter to be used in evaluation performed by the evaluator next.

18. The computer-readable non-transitory recording medium according to claim 7, wherein the model is a probability model that uses a Gaussian process.

19. The computer-readable non-transitory recording medium according to claim 7, wherein the optimizer learns the model based on the evaluation value obtained through processing in the evaluator, the upper-order parameter, and the lower-order parameter.

20. The computer-readable non-transitory recording medium according to claim 17, wherein the model is a probability model that uses a Gaussian process.

21. The computer-readable non-transitory recording medium according to claim 18, wherein the optimizer learns the model based on the evaluation value obtained through processing in the evaluator, the upper-order parameter, and the lower-order parameter.
